(19) United States
(12) Patent Application Publication
(10) Pub. No.: US 2025/0341725 A1
(43) Pub. Date: Nov. 6, 2025

(54) COMPOUND POLYMER FOR LIGHTGUIDE

(71) Applicant: LUMUS LTD., NESS ZIONA (IL)

(72) Inventors: Yochay DANZIGER, Kfar Vradim (IL); Keren RASSOVSKY, Jerusalem (IL); Amir SHAPIRA, Herzliya (IL); Ido FUCHS, Petach Tikva (IL); Eliav SILBERSTEIN, Rechovot (IL); Elad SHARLIN, Mishmar David (IL)

(73) Assignee: LUMUS LTD., NESS ZIONA (IL)

(21) Appl. No.: 18/864,384

(22) PCT Filed: May 11, 2023
(86) PCT No.: PCT/IB2023/054899

§ 371 Date: Nov. 8, 2024

Related U.S. Application Data
(60) Provisional application No. 63/341,004, filed on May 12, 2022.
(60) Provisional application No. 63/425,329, filed on Nov. 15, 2022.
(60) Provisional application No. 63/436,634, filed on Jan. 2, 2023.

(51) Int. Cl. G02B 27/01

(52) U.S. Cl. CPC G02B 27/0176; G02B 27/0172

(57) ABSTRACT

Optical systems including an optical structure, and methods for forming the optical structure, are described. The optical structure can include a lightguide having two major surfaces. The optical structure can further include a transparent plate, a first polymer later, and a second polymer layer. The first polymer layer can be arranged on one of the two major surfaces of the lightguide. A material of the first polymer layer can maintain total internal reflectance at the lightguide, and a refractive index of the first polymer layer can be less than a refractive index of the lightguide. The second polymer layer can be arranged between the first polymer layer and the transparent plate. A material of the second polymer layer can have a Young's modulus lower than a Young's modulus of the first polymer layer, and can have a refractive index greater than the refractive index of the first polymer layer.

### SUMMARY

In one embodiment, an optical system is generally described. The optical system can include a projection optics device configured to generate a light beam. The optical system can further include a light-guide optical element. The light-guide optical element can include a lightguide having two major surfaces. The light beam generated by the projection optics device and coupled into the lightguide can travel through the lightguide by reflecting off the two major surfaces. The light-guide optical element can further include a transparent plate. The light-guide optical element can further include a first polymer layer arranged on one of the two major surfaces of the lightguide. A material of the first polymer layer can be selected to maintain total internal reflectance at the lightguide, and a refractive index of the first polymer layer can be less than a refractive index of the lightguide. The light-guide optical element can further include a second polymer layer arranged between the first polymer layer and the transparent plate. A material of the second polymer layer can be selected to have a Young's modulus that can be lower than a Young's modulus of the first polymer layer, and a refractive index of the second polymer layer can be greater than the refractive index of the first polymer layer.

In one embodiment, a light-guide optical element is generally described. The light-guide optical element can include a lightguide having two major surfaces. A light beam generated by a projection optics device and coupled into the lightguide travels through the lightguide by can reflect off the two major surfaces. The light-guide optical element can further include a transparent plate. The light-guide optical element can further include a first polymer layer arranged on one of the two major surfaces of the lightguide. A material of the first polymer layer can be selected to maintain total internal reflectance at the lightguide, and a refractive index of the first polymer layer can be less than a refractive index of the lightguide. The light-guide optical element can further include a second polymer layer arranged between the first polymer layer and the transparent plate. A material of the second polymer layer can be selected to have a Young's modulus that can be lower than a Young's modulus of the first polymer layer, and a refractive index of the second polymer layer can be greater than the refractive index of the first polymer layer.

In one embodiment, a method of manufacturing a light-guide optical element is generally described. The method can include providing a lightguide comprising two major surfaces. The lightguide can be configured to allow a light beam generated by a projection optics device and coupled into the lightguide to travel through the lightguide by reflecting off the two major surfaces. The method can further include providing a transparent plate. The method can further include arranging a first polymer layer on one of the two major surfaces of the lightguide. A material of the first polymer layer can be selected to maintain total internal reflectance at the lightguide, and a refractive index of the first polymer layer can be less than a refractive index of the lightguide. The method can further include arranging a second polymer layer between the first polymer layer and the transparent plate. A material of the second layer can be selected to have a Young's modulus that can be lower than a Young's modulus of the first polymer layer, and a refractive index of the second polymer layer can be greater than the refractive index of the first polymer layer.

In one embodiment, an optical structure in an optical system is generally described. The optical structure can include a lightguide having two major surfaces. A light beam generated by a projection optics device and coupled into the lightguide can travel through the lightguide by reflecting off the two major surfaces. The optical structure can further include a first polymer layer arranged on one of the two major surfaces of the lightguide. A material of the first polymer layer can be selected to maintain total internal reflectance at the lightguide, and a refractive index of the first polymer layer can be less than a refractive index of the lightguide. The optical structure can further include a second polymer layer arranged on the first polymer layer. A material of the second layer can be selected to have a Young's modulus that can be lower than a Young's modulus of the first polymer layer, and a refractive index of the second polymer layer can be greater than the refractive index of the first polymer layer.

In one embodiment, a method of manufacturing an optical structure is generally described. The method can include providing a lightguide having two major surfaces. The lightguide can be configured to allow a light beam generated by a projection optics device and coupled into the lightguide to travel through the lightguide by reflecting off the two major surfaces. The method can further include arranging a first polymer layer on one of the two major surfaces of the lightguide. A material of the first polymer layer can be selected to maintain total internal reflectance at the lightguide, and a refractive index of the first polymer layer can be less than a refractive index of the lightguide. The method can further include arranging a second polymer layer on the first polymer layer. A material of the second layer can be selected to have a Young's modulus that can be lower than a Young's modulus of the first polymer layer, and a refractive index of the second polymer layer can be greater than the refractive index of the first polymer layer.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a schematic diagram of an example optical system according to an embodiment.

FIG. 2 is a diagram illustrating a layer of adhesive being used for attaching a layer of material to a lightguide.

FIG. 3 is a diagram illustrating a structure including more than one polymer layers being used for attaching a layer of material to a lightguide in one embodiment.

FIG. 4A is a diagram illustrating a pre-integration of multiple polymer layers in one embodiment.

FIG. 4B is a diagram illustrating a structure formed by integrating the components shown in FIG. 4A in one embodiment.

FIG. 5A is a diagram illustrating a pre-stacked configuration where a foil is used as a protective surface in one embodiment.

FIG. 5B is a diagram illustrating a stacked configuration where a foil is used as a protective surface in one embodiment.

FIG. 6A is a diagram illustrating a lightguide with a non-smooth surface coated with an anti-reflection (AR) coating.

FIG. 6B is a diagram illustrating a lower refractive index polymer layer stacked on a non-smooth surface of a lightguide in one embodiment.

FIG. 7 is a diagram illustrating examples of beams experiencing total internal reflection in a lightguide.

FIG. 8 is a diagram illustrating examples of stacking a polymer layer on a lightguide to suppress beams that can scatter due to surface deviations in one embodiment.

FIG. 9 is a diagram illustrating examples of attaching polymer layers on a lightguide to suppress beams that can scatter due to surface deviations and to filter the scattering in one embodiment.

FIG. 10 is a diagram illustrating a prevention of an unguided light beam exiting a lightguide in one embodiment.

FIG. 11 is a flow diagram illustrating a process of manufacturing a light-guide optical element in one embodiment.

FIG. 12 is a flow diagram illustrating a process of manufacturing an optical structure in one embodiment.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

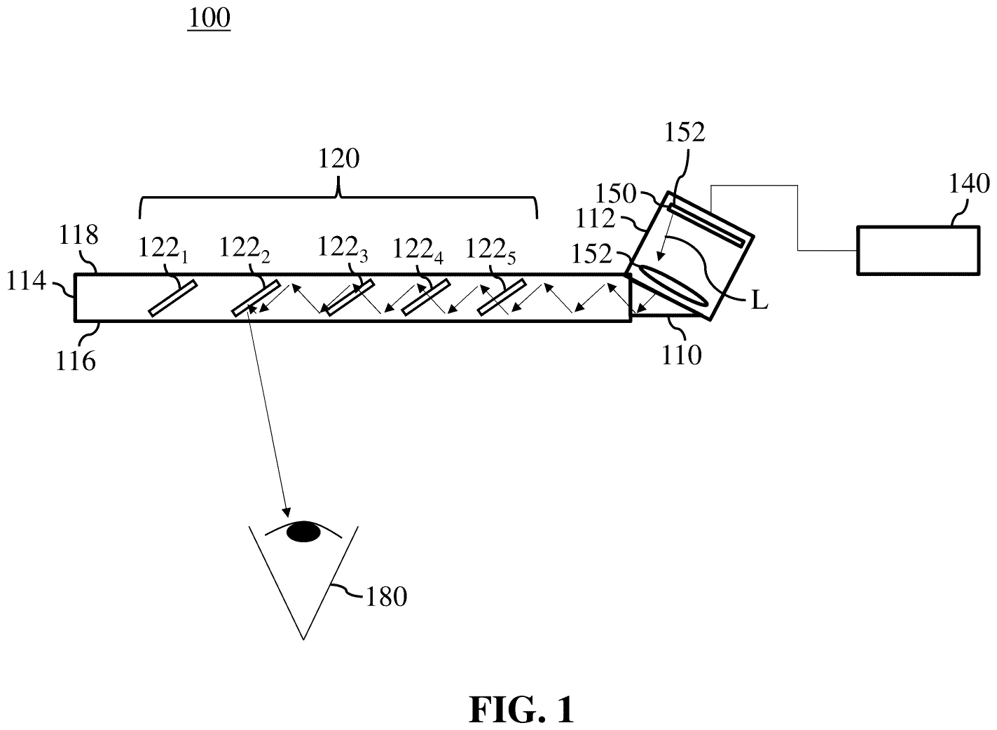

FIG. 1 is a schematic diagram of an example optical system 100 according to an embodiment. Optical system 100 can include at least an image projection assembly 110 and a controller 140. Controller 140 can include a computing device having one or more processing devices, memory or other components. For example, controller 140 can include a central processing unit (CPU), field-programmable gate array (FPGA), microcontroller, dedicated circuitry or any other components. Controller 140 can be configured to control a projection optics device (to be described below) to generate and output images to a light-guide optical element (LOE) (to be described below) for projection to an eye 180.

In some embodiments, controller 140 can be integrated into image projection assembly 110 or integrated into a device comprising image projection assembly 110 such as, e.g., glasses, a head-mounted display or another device. In some embodiments, controller 140 can be located remote from image projection assembly 110. For example, image projection assembly 110 can include a wired or wireless communication device that is configured to communicate with controller 140. As an example, controller 140 can be included as part of a mobile device, or other computing device that is separate from image projection assembly 110 or a device including image projection assembly 110.

Image projection assembly 110 can include a projection optics device (POD) 112 and a light-guide optical element (LOE) 114 and is configured to project an image onto eye 180 of the user. POD 112 can include an image generator 150, collimating optics 152 or other components that may be included in an image projection assembly such as, e.g., a spatial light modulator (SLM). Some or all of these components may be arranged on surfaces of one or more polarizing beam splitter (PBS) cubes or other prism arrangements in some embodiments. Image generator 150 comprises one or more components that provide illumination, e.g., light beams, laser beams or other forms of illumination, that correspond to an image to be projected onto eye 180 of the user. For example, image generator 150 comprises light emitting diodes (LED) display, an organic light emitting diodes (OLED) display, a backlit liquid crystal display (LCD) panel, a micro-LED display, a digital light processing (DLP) chip, a liquid crystal on silicon (LCOS) chip or other components.

Alternatively, POD 112 can include a scanning arrangement, e.g., a fast-scanning mirror, which scans illumination from a light source across an image plane of POD 112 while the intensity of the illumination is varied synchronously with the motion on a pixel-by-pixel basis to project a desired intensity for each pixel. POD 112 can also optionally include a coupling-in arrangement for injecting the illumination of the image into LOE 114, e.g., a coupling-in reflector, angled coupling prism or any other coupling-in arrangement. In some embodiments, coupling between POD 112 and LOE 114 may include a direct coupling, e.g., POD 112 can be in contact with a portion of LOE 114, or may include a coupling via an additional aperture expanding arrangement for expanding the dimension of the aperture across which the image is injected in the plane of LOE 114.

LOE 114 can include a lightguide including first and second parallel major LOE surfaces 116 and 118 and edges that are not optically active. In illustrative embodiments, the various lightguides described herein may comprise geometric lightguides, diffractive lightguides or any other types of lightguide. LOE 114 also includes a coupling-out arrangement 120 that is configured to direct the illumination out of LOE 114 for projection onto eye 180 of the user. In some embodiments, coupling-out arrangement 120 is illustrated as a plurality of embedded partial reflectors (also referred to as facets) 122₁, 122₂, 122₃, 122₄ and 122₅, that are arranged within LOE 114 at an oblique angle to major LOE surfaces 116 and 118 of LOE 114. While five embedded partial reflectors 122₁, 122₂, 122₃, 122₄ and 122₅ are illustrated in FIG. 1, in an illustrative embodiment, LOE 114 can alternatively include a larger number of embedded partial reflectors or a smaller number of embedded partial reflectors in other embodiments.

In some embodiments, each embedded partial reflector is configured to couple out light beams having particular angles of propagation in LOE 114 to eye 180. For example, in some embodiments, each embedded partial reflector is configured to couple-out light beams having different angles of propagation in LOE 114. In some embodiments, one or more of the embedded partial reflectors may be selectively activatable, by controller 140, between a state in which the embedded partial reflector has a high transmissivity of light and a state in which the embedded partial reflector has a high reflectivity of light. Aperture expansion or multiplication can also be in two dimensions, where another set of facets reflects laterally to perform aperture multiplication.

As shown in FIG. 1, for example, light beam L travels through LOE 114 towards the embedded partial reflectors by reflecting off major LOE surfaces 116 and 118. For example, major LOE surfaces 116 and 118 may provide TIR for any light beams traveling through LOE 114. When light beam L encounters an embedded partial reflector at the right angle, or an active embedded partial reflector, light beam L is redirected by the embedded partial reflector. Light encountering embedded partial reflectors is redirected out of LOE 114, e.g., towards eye 180.

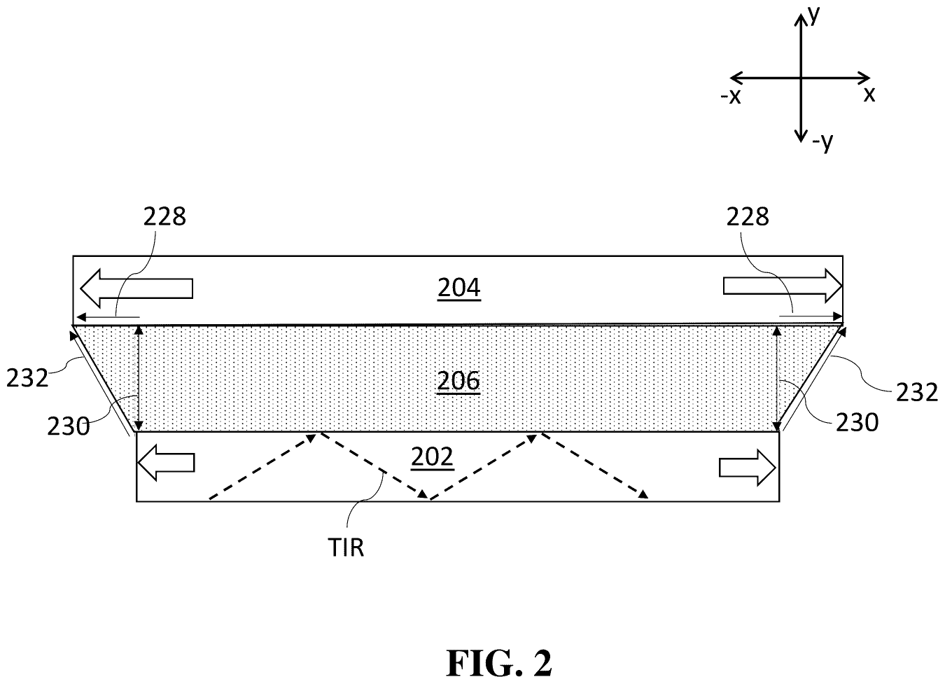

FIG. 2 is a diagram illustrating a layer of adhesive being used for attaching a layer of material to a lightguide. In an example shown in FIG. 2, a layer of material (e.g., a transparent plate), such as a polycarbonate plate 204, can be disposed on a lightguide 202 using a layer of adhesive 206. In one or more embodiments, the layer of material shown as polycarbonate plate 204 can be polymer, glass, or other materials forming a transparent plate or transparent layer of materials. Adhesive 206 can be used for attaching a surface of lightguide 202 to a surface of polycarbonate plate 204. Lightguide 202 can be a light-guide optical element, such as LOE 114 shown in FIG. 1. In the example shown in FIG. 2, broken line arrows represent (TIR) guided light reflected by reflectors within lightguide 202. Polycarbonate plate 204 is shown as having a top surface that is flat, however, the top surface of polycarbonate plate 204 can also be curved. In an aspect, adhesive 206 can be sufficiently flexible for the thermal expansion while having a lower refractive index relative to lightguide 202 such that TIR within lightguide 202 is preserved.

Polycarbonate plate 204 and lightguide 202 can expand, such as expanding horizontally in the ±x directions. Due to the different CTEs between polycarbonate plate 204 and lightguide 202, the surface of adhesive 206 that is attached to polycarbonate plate 204 can expand faster than the surface of adhesive 206 that is attached to lightguide 202. For example, if both of polycarbonate plate 204 and lightguide 202 are exposed to a 30-degree Celsius temperature change, lightguide 202 can expand laterally (along x-axis) by approximately 3 microns and polycarbonate plate 204 can expand laterally by approximately 32 microns. Hence, the expansion difference, or relative expansion, between polycarbonate plate 204 and lightguide 202 is approximately 29 microns as shown by relative expansion 228 in FIG. 2.

Relative expansion 228 can stretch a top surface of adhesive 206 and cause the sides of adhesive 206 to extend and deform in a diagonal direction (e.g., xy direction and −xy direction) as shown by extensions 232. In an aspect, specific types of polymer may show signs of fatigue after stretching laterally (e.g., along the x-axis) by approximately 18% of a thickness (e.g., along the y-axis) of the polymer. Hence, if a length of extension 232 is greater than a thickness 230 of adhesive 206 by a specific threshold (e.g., by 18% of the thickness of the polymer), adhesive 206 may break and polycarbonate plate 204 may fall towards lightguide 202, which can reduce the transparency of lightguide 202 and can cause unwanted materials (e.g., dirt) to be attached to lightguide 202. By way of example, if relative expansion 228 is approximately 29 microns, then a thickness 230 of adhesive needs to be approximately 45 microns in order for a 29-micron relative expansion (e.g., 232) to be no more than 18% greater than thickness 230. Therefore, a thicker adhesive layer can accommodate larger amounts of lateral expansion of polycarbonate plate 204.

However, the thicker adhesive layer may significantly increase device size, and light passing through the thicker adhesive layer can be unstable. For example, occurrences of internal and external scattering can increase as the thickness of the adhesive layer increases. The scattered light caused by the thicker adhesive layer can also perturb the TIR inside lightguide 2. Reducing the thickness of adhesive 206 can be beneficial as it can reduce the risk of scattering and perturbance, and maintain TIR within lightguide 202. However, simply reducing a thickness of adhesive 206 can increase the risk of breaking (e.g., less thickness can make it easier to pass the 18% threshold or other threshold for other types of polymers). Therefore, there is a need to optimize the thickness of the polymer being used as adhesives to attach polycarbonate plate 204 to lightguide 202 while preventing the adhesive from breaking, and to maintain TIR within lightguide 202 by having a refractive index of the material of adhesive 206 be relatively low relative to lightguide 202 so TIR is preserved. Further, it is difficult to use a single material that can provide both 1) mechanical flexibility and adhesion to accommodate the CTE difference between polycarbonate plate 204 with lightguide 202, and 2) low refractive index relative to lightguide 202 in order to maintain TIR.

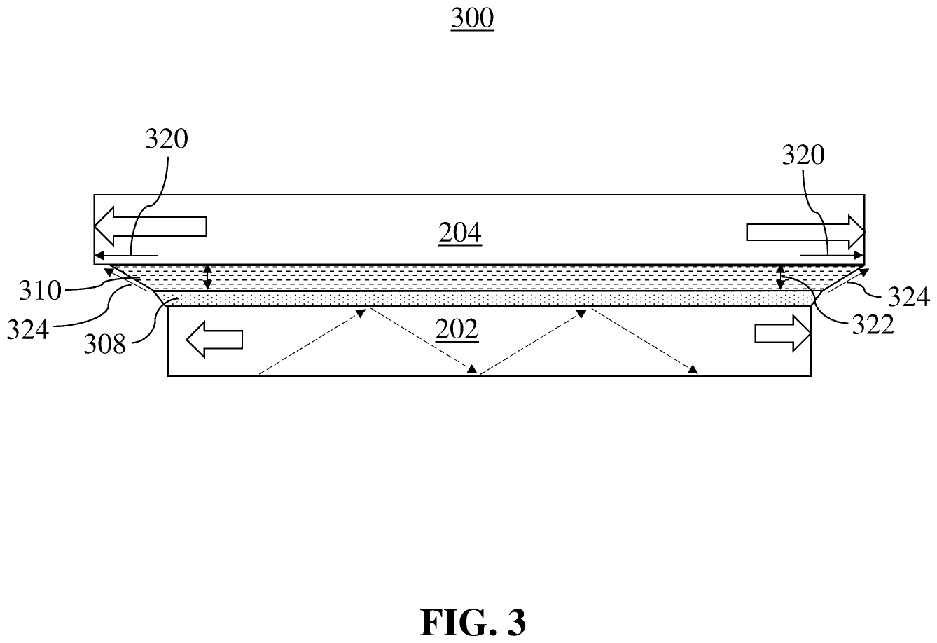

FIG. 3 is a diagram illustrating a structure 300 including more than one polymer layers being used for attaching a layer of material (e.g., polycarbonate plate 204) to a lightguide (e.g., lightguide 202) in one embodiment. To maintain TIR within lightguide 202 and to reduce the thickness of adhesive being used to attach polycarbonate plate 204 and lightguide 202, more than one layers of polymer can be used in place of adhesive 206 in FIG. 2. In structure 300 shown in FIG. 3, a layer of polymer 308 (or polymer layer 308) is directly attached to lightguide 202 and another layer of polymer 310 (or polymer layer 310) is directly attached to polymer layer 308 and polycarbonate plate 204. In one embodiment, polymer layers 308, 310 can be composed of different types of adhesive materials. In another embodiment, at least one surface of at least one of polymer layers 308, 310 can be pre-applied with adhesives.

Polymer layer 308 can be a relatively thin layer of low refractive index polymer that preserves the TIR in lightguide 202. A thickness of polymer layer 308 can be, for example, less than 10 microns such as 1 to 2 microns thick. In one embodiment, a refraction index of polymer layer 308 can be less than a refraction index of lightguide 202 in order to maintain TIR in lightguide 202. Polymer layer 310 can be a flexible layer of polymer having elongation of, for example, 140% before break (e.g., the 140% elongation is in the same direction as an extension 324 being shown in FIG. 3). Polycarbonate plate 204 can be arranged above polymer layer 310. In one embodiment, polymer layer 310 can be served as a dump chock between polycarbonate plate 204 and lightguide 202 and can absorb vibrations experienced by structure 300. In one embodiment, a thicknesses of polymer layer 310 can be approximately 13 microns, which is significantly thinner than the example shown in FIG. 2 where the layer of adhesive 206 can be approximately 45 microns. Polymer layer 310 can serve as a layer of adhesive to attach polycarbonate plate 204. The above-described parameters and dimensions are for illustration only and other dimensions are possible.

To prevent damage to polymer layer 308, polymer layer 310 can have a lower Shore hardness relative to polymer layer 308. Alternatively, the Young's modulus of the material of polymer layer 310 can be lower than the Young's modulus of the material of polymer layer 308. Polymer layer 310 having a lower Short hardness and Young's modulus than polymer layer 308 can accommodate the different expansion rate of polycarbonate plate 204 and lightguide 202. In one embodiment, the CTE of the flexible polymer layers 308, 310 can be negligible when compared to the CTE of polycarbonate plate 204 and lightguide 202. By way of example, as polycarbonate plate 204 and lightguide 202 expand in response to temperature changes, expansion of polycarbonate plate 204 can stretch a top (e.g., +x direction) surface of polymer layer 310 at a first rate proportional to the CTE of polycarbonate plate 204, and lightguide 202 can stretch a bottom (e.g., −x direction) surface polymer 308 at a second rate that is lower than the first rate and proportional to the CTE of lightguide 202.

By way of example, a relative expansion 320 between polycarbonate plate 204 and polymer layer 308 is shown in FIG. 3. Relative expansion 320 can be less than a relative expansion between polycarbonate plate 204 and lightguide 202 due to the independent stretching of polymer layers 308, 310. The relative expansion 320 in FIG. 3, instead of relative expansion between polycarbonate plate 204 and lightguide 202, can control a size or length of extension 324. Extension 324 can be measured from a surface of polymer layer 308, instead of measured from a surface of lightguide 202 when compared to configurations where a single layer of polymer is between polycarbonate plate 204 and lightguide 202 (e.g., FIG. 2). Therefore, extension 324 can be reduced when compared to the configuration shown in FIG. 2. The reduced extension can delay breaking of the adhesive layer (e.g., polymer layer 310). The usage of more than one polymer layers between polycarbonate plate 204 and lightguide 202, as shown in FIG. 3, can provide functionality separation since polymer layer 308 can provide the low refractive index for maintaining TIR while polymer layer 310 can provide the mechanical flexibility and adhesion to accommodate the CTE difference between polycarbonate plate 204 with lightguide 202.

In one embodiment to manufacture structure 300, prior to bonding, lightguide 202 can undergo physical and chemical pre-treatment (e.g., plasma/corona or other with silane or similar) to induce high adhesion of polymer layer 308 to lightguide 202. Polymer layer 308 can be applied to a surface of lightguide 202 by, for example, spin coating and cured in open air environment.

In a variation of the embodiment, the polymer of polymer layer 308 does not include any components in its formulation that will suppress oxygen inhibition. Under this embodiment, oxygen inhibition occurs on a surface layer (e.g., approximately 1-2 microns of thickness) of polymer layer 308 such that while the bulk of the polymer of polymer layer 308 undergoes full cure, the upper layer of polymer layer 308 remains uncured.

The bonding of polycarbonate plate 204 to polymer layer 308 can include applying polymer of polymer layer 310 as an intermediate adhesive with a specific CTE and elongation on the wet uncured surface of polymer layer 308. The separate bonding of two separate layers of adhesives (e.g., polymer layers 308, 310) between polycarbonate plate 204 and lightguide 202 to assimilate, diffuse, interact and cross-bond when exposed to curing conditions (e.g., UV, heat, etc.) can achieve high bonding strength without the need to perform additional pretreatment.

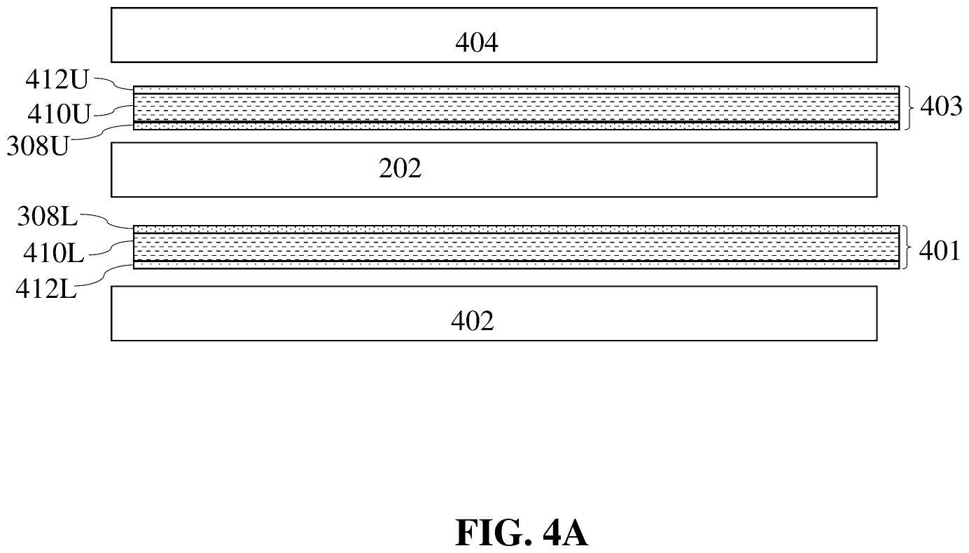

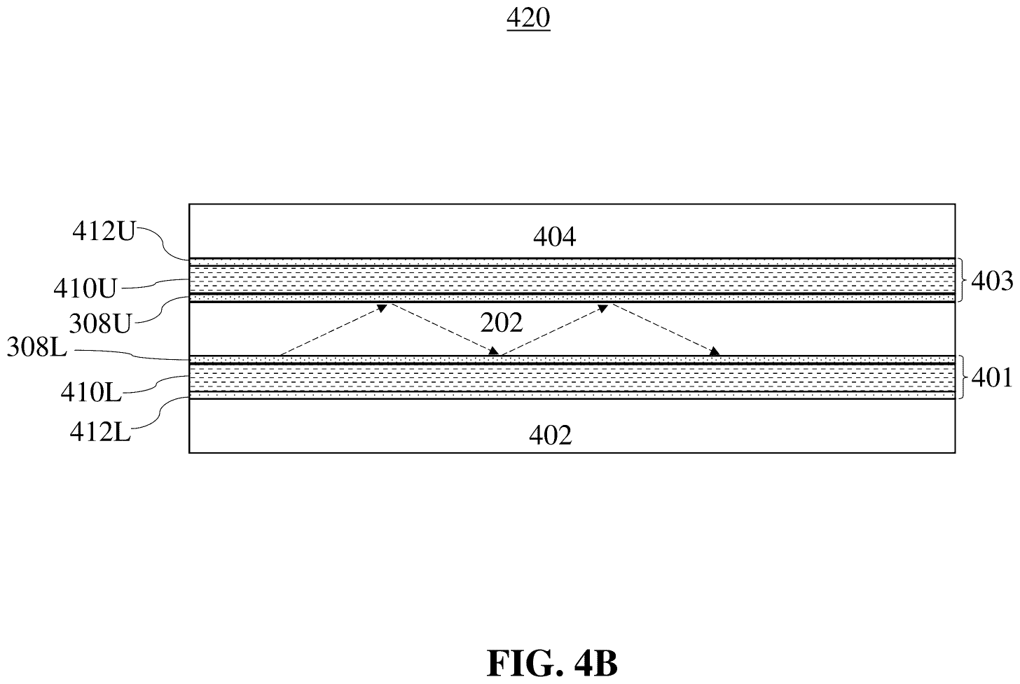

FIG. 4A is a diagram illustrating a pre-integration of multiple polymer layers in one embodiment. In one embodiment shown in FIG. 4A, a polycarbonate plate 402 can be attached to a bottom surface of lightguide 202 via a polymer structure 401 and another polycarbonate plate 404 can be attached to a top surface of lightguide 202 via a polymer structure 403. Polymer structure 401 can be a stack of polymer layers including polymer layers 308L, 410L, 412L. Polymer structure 403 can be a stack of polymer layers including polymer layers 308U, 410U, 412U.

Referring back to FIG. 3, polymer layers 308U, 308L in polymer structures 401, 403 can be composed by the same materials as polymer layer 308 shown in FIG. 3. Also, polymer layers 410U, 410L in polymer structures 401, 403 can be composed by the same materials as polymer layer 310 shown in FIG. 3. Further, polymer layers 310 in FIG. 3 and polymer layers 410U, 410L in FIG. 4A can be composed of the same materials, such as flexible polymer having lower Shore hardness than polymer layer 308 and lower Young's modulus than polymer layer 308. In one embodiment, polymer layers 412U, 412L can be composed of a polymer material different from the materials of polymer layer 308U, 308L, 410L, 410U. Polymer layer 412U can serve as adhesion for adhering polymer layer 410U to polycarbonate plate 404, and polymer layer 412L can serve as adhesion for adhering polymer layer 410L to polycarbonate plate 402. Polymer layers 412U, 412L can be optically transparent, can have refractive index between refractive indices of polymer layer 410U and polycarbonate plate 404, or between polymer layer 410L and polycarbonate plate 402, can include AR coating, and/or be mechanically flexible.

In one embodiment, polymer structure 401 can be formed or constructed by stacking polymer layer 410L on polymer layer 412L, and thereafter stacking polymer layer 308L on polymer layer 410L. In another embodiment, polymer structure 401 can be formed or constructed by stacking polymer layer 410L on polymer layer 308L, then stacking polymer layer 412L on polymer layer 410L, and thereafter flipping the entire stacked structure to complete formation of polymer structure 401.

In one embodiment, polymer structure 403 can be formed or constructed by stacking polymer layer 410U on polymer layer 412U, and thereafter stacking polymer layer 308U on polymer layer 410U. In another embodiment, polymer structure 403 can be formed or constructed by stacking polymer layer 410U on polymer layer 308U, then stacking polymer layer 412U on polymer layer 410U, and thereafter flipping the entire stacked structure to complete formation of polymer structure 403.

Each of polymer layers 410L, 410U (e.g., the flexible polymer layers) can be fabricated separately as a foil (sometimes referred to as “laminated”). For example, polymer layer 308U can applied directly to one surface of this foil (e.g., top or bottom) and an additional layer, such as polymer layer 412U, can be applied on the opposing surface (e.g., bottom or top) of this foil. Each of polymer layers 410L, 410U can also function as a protective layer to hold remnants of lightguide 202 in a case where lightguide 202 breaks, thus improving safety to users.

Polymer structures 401, 403 can be manufactured separately before being integrated with lightguide 202 and polycarbonate plates 402, 404 to form a structure 420 shown in FIG. 4B. In FIG. 4B, polymer structure 401 can be situated between a bottom surface of lightguide 202 and polycarbonate plate 402. Polymer structure 403 can be situated between a top surface of lightguide 202 and polycarbonate plate 404. In one embodiment, structure 420 can be formed by stacking polymer structure 401 on top of polycarbonate plate 402, then lightguide 202 can be stacked on top of polymer structure 401, then polymer structure 403 can be stacked on top of lightguide 202, then thereafter polycarbonate plate 404 can be stacked on top of polymer structure 404.

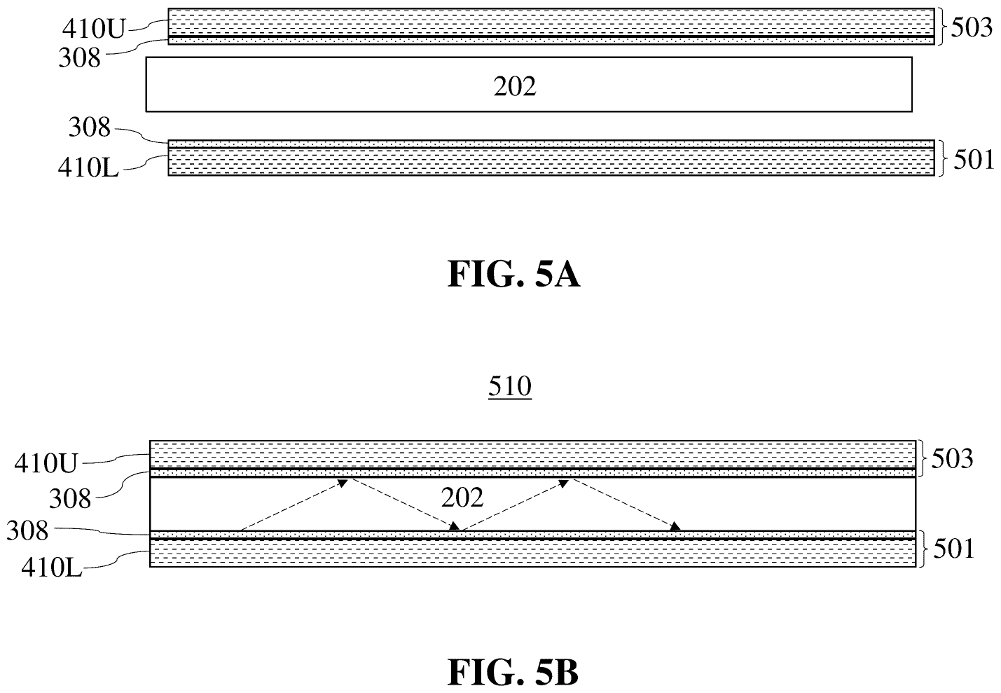

FIG. 5A is a diagram illustrating a pre-stacked configuration where a foil is used as a protective surface in one embodiment. In an embodiment shown in FIG. 5A, polymer layer 410L can be attached to polymer layer 308 to form a first protective structure 501, and polymer layer 410U can be attached to another polymer layer 308 to form a second protective structure 503. Polymer layers 410L, 410U can serve as a foil that protects users in cases of breakage. After forming first and second protective structures 501, 503, first and second protective structures 501, 503 can be attached to, and stacked with, lightguide 202 to form a stacked structure 510 shown in FIG. 5B. In one embodiment, since polymer layers 410U, 410L are flexible, polymer layers 410U, 410L can also be stretchable thus alleviating challenges caused by thermal expansion.

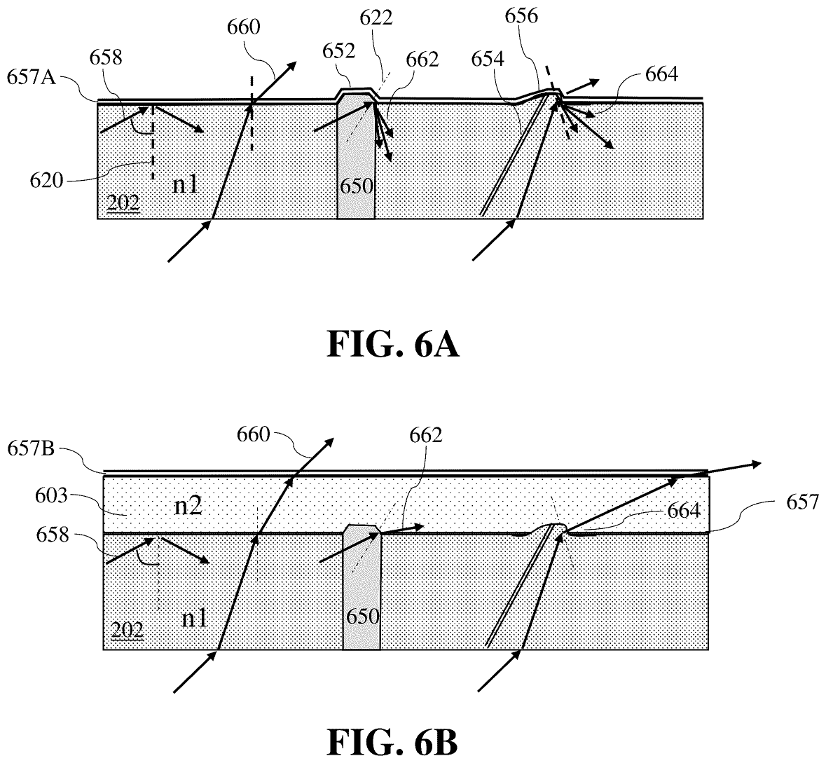

FIG. 6A is a diagram illustrating a lightguide with a non-smooth surface coated with an anti-reflection (AR) coating. In an example shown in FIG. 6A, lightguide 202 can have a non-smooth surface coated with an anti-reflection (AR) coating 657A. The deviation from smoothness forming the non-smooth surfaces can be a result of, for example, a component 650 in lightguide 202 causing a deviation 652, or an embedded partial reflector 654 generating a deviation 656. Deviations 652, 656 are shown as bumps in FIG. 6A, however, deviations 652, 656 can also be a depression of a surface of lightguide 202. A reflection 658 in FIG. 6A shows an optimal reflection where a beam is reflected by TIR and an angle of reflection equals the angle of incidence as measured locally from the surface vertex 620 (vertical dashed line). A transmission 660 represents an unperturbed transmitting beam. In an aspect, the unperturbed transmitting beam can also originate by reflection from embedded partial reflector 654.

Internal reflections 662 at the surface of deviation 652 can cause a beam to deviate at a slightly different angle, as shown by another surface vertex 622 (tilted dotted line) and be scattered thereby degrading a quality of TIR guided light and image within lightguide 202. Transmitted beam 664 may also be scattered both internally in lightguide 202 and externally outside of the surface of lightguide 202, hence degrading TIR guided image quality. The AR coating 657A is inherently following the surface pattern, therefor may not suppress these scatterings and can cause further scattering and image degradation.

FIG. 6B is a diagram illustrating a low refractive index polymer layer stacked on a non-smooth surface of a lightguide in one embodiment. FIG. 6B shows that scatterings of transmitted beam 664 can be substantially suppressed by stacking a polymer layer 603 on a surface of lightguide 202. Polymer layer 603 can be a low refractive index layer and can be the same or similar as polymer layer 308 shown in FIG. 3. Polymer layer 603 can have a refractive index n2 and n2 can be less than a refractive index n1 of lightguide 202. Refractive index n2 can be less than refractive index n1 in order to maintain TIR within lightguide 202. An outer surface of polymer layer 603 can be polished (e.g., objects similar to component 650 or partial reflector 654 are not embedded in polymer layer 603) such that optimal and smooth AR coating 657B can be implemented on top of polymer layer 603.

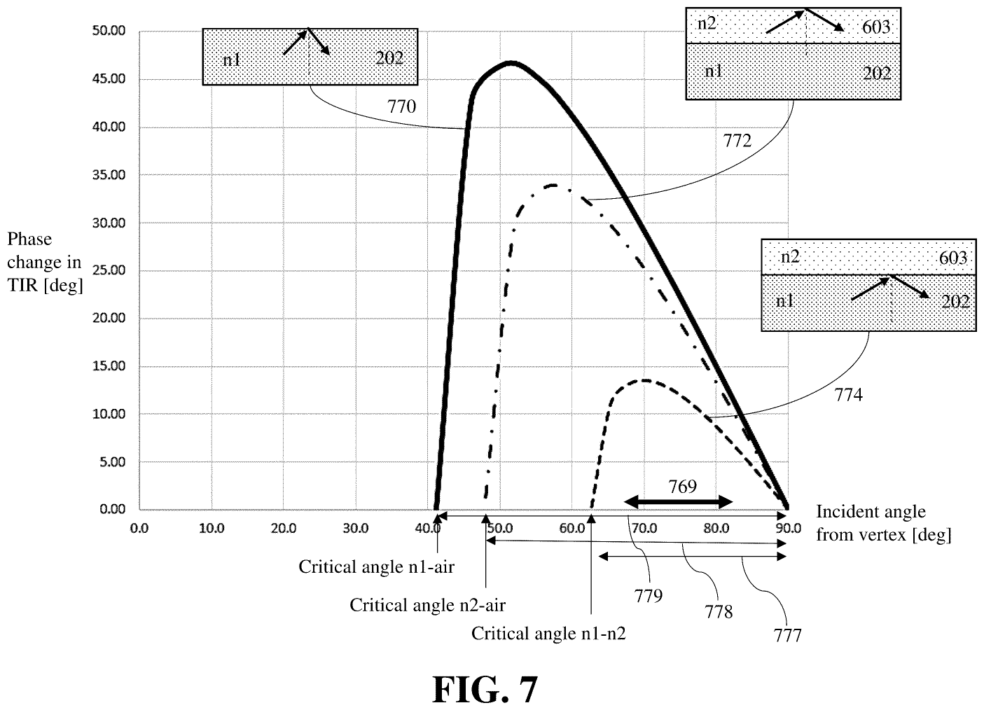

FIG. 7 is a diagram illustrating examples of beams experiencing total internal reflection in a lightguide. A plot of a phase change of light beams experiencing TIR in lightguide 202 is shown in FIG. 7, where lightguide 202 can have a smooth surface. The x-axis in FIG. 7 represents an angle of incidence of beams experiencing TIR inside lightguide 202 and the y-axis represents the phase change of the TIR beams in degrees (e.g., 360 degrees equivalent to 2π). FIG. 7 also shows three different configurations of lightguide 202 with a smooth or planar surface (e.g., ideal cases) that can guide an image under a limited angular range 769.

A first plot 770 corresponds to a first case where light beams are refracted at a surface of lightguide 202 that interface with air. First plot 770 represents a variation of a phase change of the light beams with respect to an incident angle from a vertex that interface the surface of lightguide 202 with air. A refractive index n1 of lightguide 202 can be, for example, 1.52. A range 779 in plot 770 represents an angular range of TIR in the first case, and under the first case, beams that refract at incident angles lower than a critical angle of approximately 41 degrees will not experience TIR and will may not remain inside lightguide 202.

A second plot 772 corresponds to a second case where light beams are refracted at a surface of polymer layer 603 (see FIG. 3) that interface with air. Second plot 772 represents a variation of a phase change of the light beams with respect to an incident angle from a vertex that interface the surface of polymer layer 603 with air. A refractive index n2 of polymer layer 603 can be, for example, 1.35. A range 778 in plot 770 represents an angular range of TIR in the second case, and under the second case, beams that refract at incident angles lower than a critical angle of approximately 48 degrees will not experience TIR and will may not remain inside polymer layer 603.

A third plot 774 corresponds to a third case where light beams are refracted at a surface of lightguide 202 that interface with polymer layer 603. Third plot 774 represents a variation of a phase change of the light beams with respect to an incident angle from a vertex that interface the surface of lightguide 202 with polymer layer 603. A range 777 in plot 770 represents an angular range of TIR in the third case, and under the third case, beams that refract at incident angles lower than a critical angle of approximately 63 degrees will not experience TIR and will may not remain inside lightguide 202. In one embodiment, a value of n2, or the materials composing polymer layer 603, can be selected to fit within range 777 to guide light beams under the limited angular range 769.

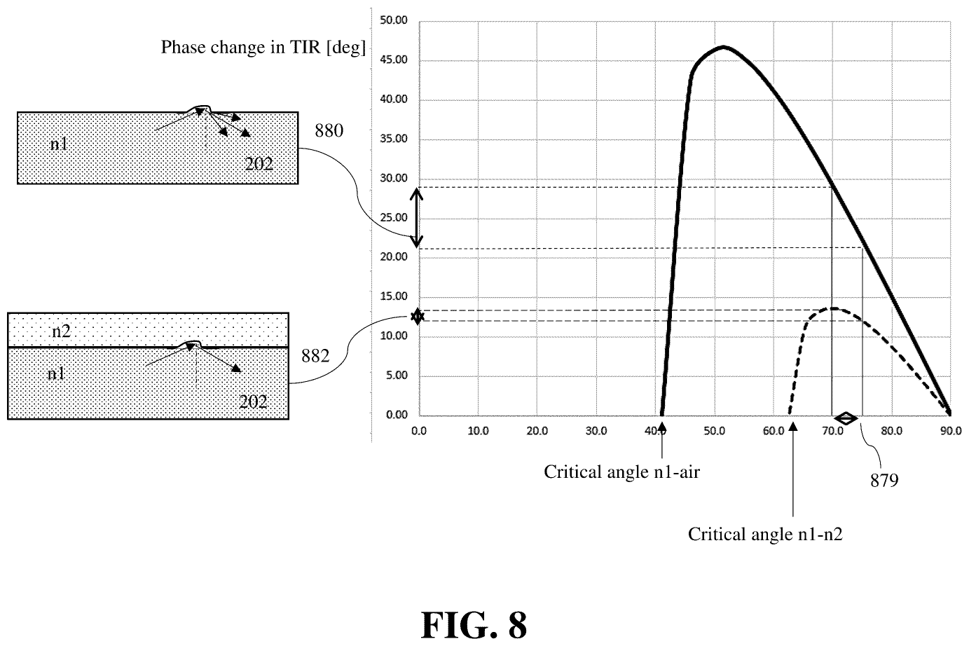

FIG. 8 is a diagram illustrating examples of stacking a polymer layer on a lightguide to suppress beams that can scatter due to surface deviations in one embodiment. A plot of a phase change of light experiencing TIR in lightguide 202 is shown in FIG. 8, where lightguide 202 can have a non-smooth surface. The x-axis in FIG. 8 represents an angle of incidence of beams experiencing TIR inside lightguide 202 and the y-axis represents the phase change of the TIR beams in degrees (e.g., 360 degrees equivalent to 2π). FIG. 8 also shows two different configurations of lightguide 202 with a non-smooth surface.

In an example shown in FIG. 8, the non-smooth surface of lightguide 202 can cause a vertex deviation 879 of approximately 5 degrees. In a first case 880, where the vertex deviation 879 interfaces with air, the phase change of light beams is approximately 8 degrees. In a second case 882, where polymer layer 603 is stacked on the non-smooth surface of lightguide 202, the phase change of light beams at vertex deviation 879 is approximately 2 degrees. Therefore, the addition of polymer layer 603 on a non-smooth surface of lightguide 202 can suppress scattering of light beams at non-smooth portions of lightguide 202 and maintain TIR in lightguide 202.

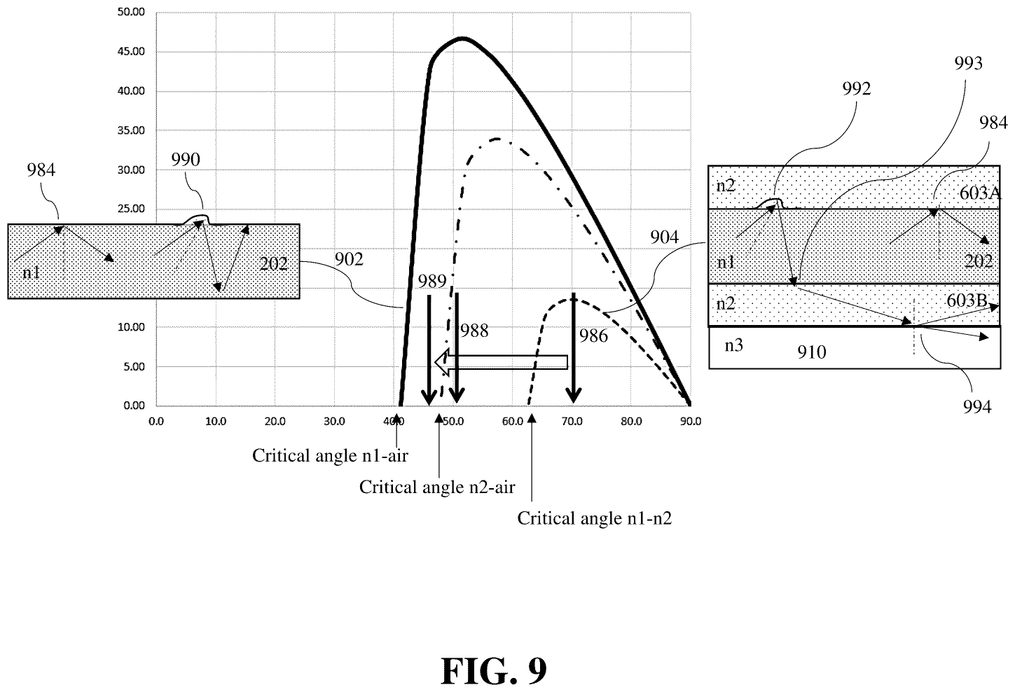

FIG. 9 is a diagram illustrating examples of attaching polymer layers on a lightguide to suppress beams that can scatter due to surface deviations and to filter the scattering in one embodiment. In a first case 902, an optimal TIR 984 on a smooth portion of a surface of lightguide 202, and a perturbed TIR 990 on a non-smooth portion of a surface of lightguide 202, are shown in FIG. 9. The reflected beam in perturbed TIR 990 is at a different angle from optimal TIR 984 but continues to be guided therefore perturbing the light beams.

In a second case 904, different polymer layers 603A, 603B having refractive index n2 are attached to both surfaces (e.g., top and bottom) of lightguide 202. Polymer layers 603A, 603B can be composed of the same materials as polymer layer 603 in FIG. 6 and polymer layer 308 in FIG. 3. A medium 910 having a refractive index n3 is attached to a bottom surface underneath polymer layer 603B. Under second case 904, a reflection 992 (that can be same as 990) can occur at a non-smooth portion of a surface of lightguide 202 that interfaces with polymer layer 603A. Reflection 992 can cause a deviated beam to reflect at another angle that causes the deviated beam to exit the lightguide 202 at a point 993 that interfaces lightguide 202 with polymer layer 603B. The deviated beam that exited at point 993 may couple out, possibly to medium 910 or may be shallowly guided along polymer layer 603B. In either case, distortion of beams in lightguide 202 can be reduced as shown in FIG. 9, where original beam angle 986 guided in lightguide 202 is reflected by perturbation as angles 988, 989, which are outside of the guidance range of lightguide 202.

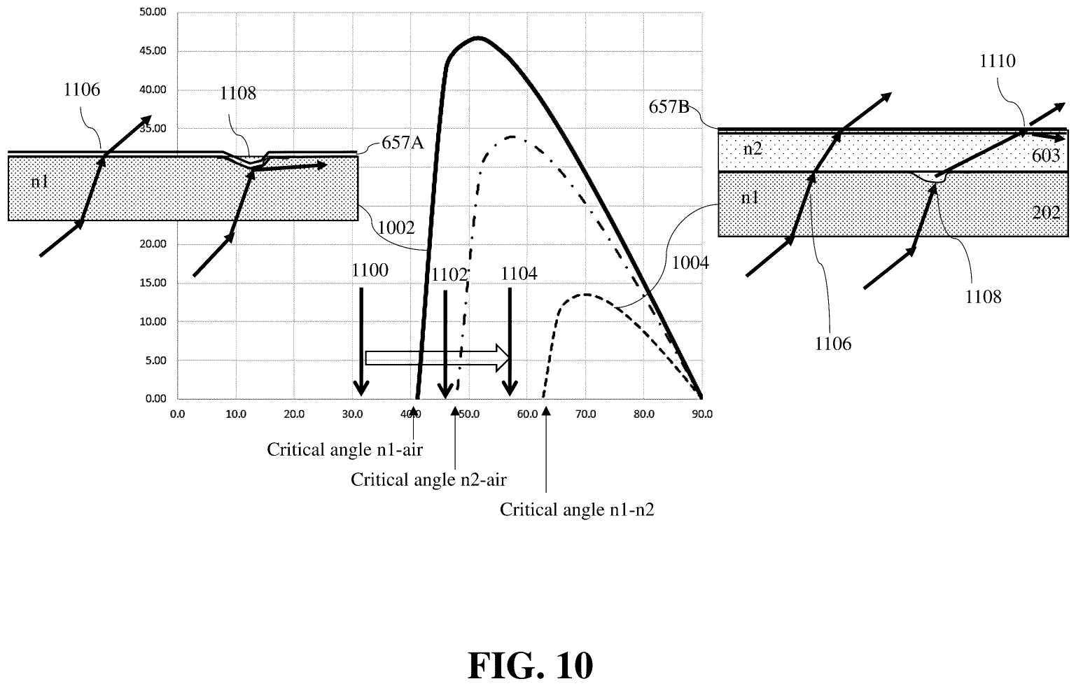

FIG. 10 is a diagram illustrating a prevention of an unguided light beam exiting a lightguide in one embodiment. In a first case 1002, an unguided beam 1106 (e.g., from scenery or reflected by facets) is shown as passing out or exiting lightguide 202 at a smooth portion of the surface of lightguide 202 coated with AR coating 657A. At a non-smooth portion of the surface of lightguide 202, a perturbation 1108 can cause this beam to become guided.

In a second case 1004, polymer layer 603 is stacked directly on lightguide 202 and a surface of polymer layer 603 is coated with AR coating 657B. In the second case 1004, perturbation 108 can cause the beam to deflect but not maintain guidance in lightguide 202. The deflected beam can couple out from polymer layer 603 due to smooth AR coating 657B or another medium, or can deflect at very shallow angle within polymer layer 603. The perturbed beam is not guided in lightguide 202 and therefor image degradation is reduced, as shown in FIG. 10 where unguided beam 1100 is diverted to 1102 or 1104 that are guided under the first case 1002 but not the second case 1004.

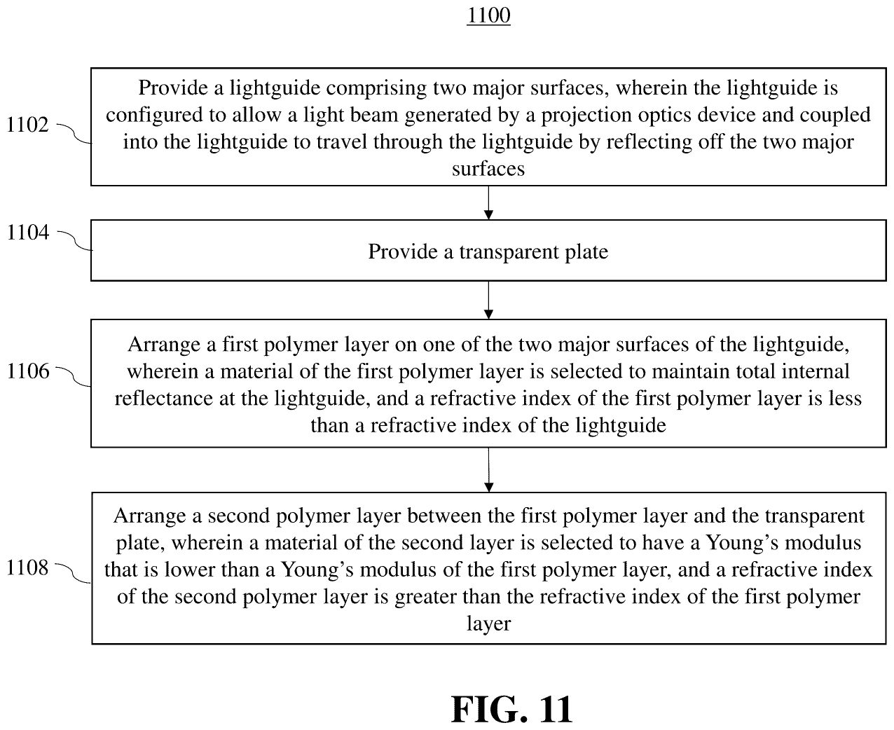

FIG. 11 is a flow diagram illustrating a process of manufacturing a light-guide optical element in one embodiment. The process 1100 may include one or more operations, actions, or functions as illustrated by one or more of blocks 1102, 1104, 1106 and/or 1108. Although illustrated as discrete blocks, various blocks can be divided into additional blocks, combined into fewer blocks, eliminated, or performed in parallel, and/or performed in different order, depending on the desired implementation.

Process 1100 can be performed for manufacturing a light-guide optical element, such as structures 300, 420 in FIG. 3, FIG. 4B. Process 1100 can begin at block 1102. At block 1102, a lightguide can be provided, where the lightguide can include two major surfaces. The lightguide can be configured to allow a light beam generated by a projection optics device and coupled into the lightguide to travel through the lightguide by reflecting off the two major surfaces. In one embodiment, a coupling-out arrangement can be provided in the lightguide, where the coupling-out arrangement can be configured to direct light guided by the lightguide out of the lightguide. In one embodiment, the coupling-out arrangement can include a plurality of surfaces arranged within the lightguide at one or more oblique angles to the major lightguide surfaces.

Process 1100 can proceed from block 1102 to block 1104. At block 1104, a transparent plate can be provided. In one embodiment, the transparent plate can have a larger constant of thermal expansion relative to the lightguide.

Process 1100 can proceed from block 1104 to block 1106. At block 1106, a first polymer layer can be arranged on one of the two major surfaces of the lightguide. A material of the first polymer layer can be selected to maintain total internal reflectance at the lightguide, and a refractive index of the first polymer layer can be less than a refractive index of the lightguide. In one embodiment, the first polymer layer can be arranged on the one of the two major surfaces by adhering the first polymer layer on the one of the two second major surfaces of the lightguide. In one embodiment, a material of the first polymer layer can be selected to allow oxygen inhibition to occur on a surface layer of the first polymer layer not in contact with the one of the two major surfaces of the lightguide.

Process 1100 can proceed from block 1106 to block 1108. At block 1108, a second polymer layer can be arranged between the first polymer layer and the transparent plate. A material of the second layer can be selected to have a Young's modulus that is lower than a Young's modulus of the first polymer layer, and a refractive index of the second polymer layer can be greater than the refractive index of the first polymer layer. In one embodiment, a Shore hardness of the second polymer layer can be selected to be lower than a Shore hardness of the first polymer layer. In one embodiment, a portion of the first polymer layer can undergo curing while the surface layer of the first polymer layer remains uncured, and the second polymer layer can be applied to the uncured surface layer of the first polymer layer.

In one embodiment, a third layer can be provided and arranged between the second polymer layer and the transparent plate. In one embodiment, the first polymer layer, the second polymer layer and the third layer can be formed as a laminated structure before arranging the first polymer layer on the one of the two major surfaces of the lightguide and arranging the transparent plate on the third layer.

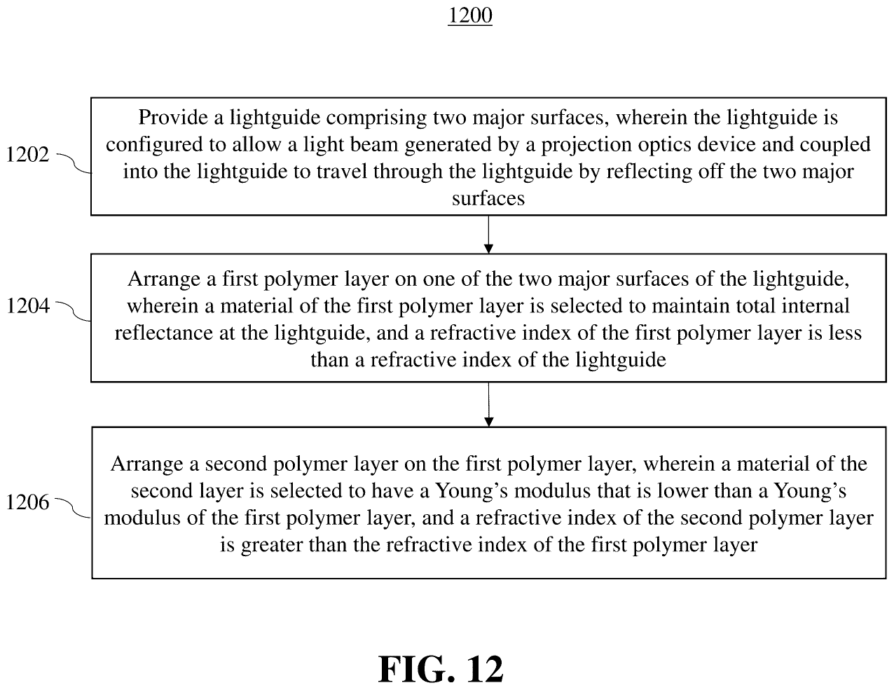

FIG. 12 is a flow diagram illustrating a process of manufacturing an optical structure in one embodiment. The process 1200 may include one or more operations, actions, or functions as illustrated by one or more of blocks 1202, 1204, and/or 1206. Although illustrated as discrete blocks, various blocks can be divided into additional blocks, combined into fewer blocks, eliminated, or performed in parallel, and/or performed in different order, depending on the desired implementation.

Process 1200 can be performed for manufacturing a light-guide optical element, such as structure 510 in FIG. 5B. Process 1200 can begin at block 1202. At block 1202, a lightguide can be provided, where the lightguide can include two major surfaces. The lightguide can be configured to allow a light beam generated by a projection optics device and coupled into the lightguide to travel through the lightguide by reflecting off the two major surfaces. In one embodiment, a coupling-out arrangement can be provided in the lightguide, where the coupling-out arrangement can be configured to direct light guided by the lightguide out of the lightguide. In one embodiment, the coupling-out arrangement can include a plurality of surfaces arranged within the lightguide at one or more oblique angles to the major lightguide surfaces.

Process 1200 can proceed from block 1202 to block 1204. At block 1204, a first polymer layer can be arranged on one of the two major surfaces of the lightguide. A material of the first polymer layer can be selected to maintain total internal reflectance at the lightguide, and a refractive index of the first polymer layer can be less than a refractive index of the lightguide. In one embodiment, the first polymer layer can be arranged on the one of the two major surfaces by adhering the first polymer layer on the one of the two second major surfaces of the lightguide. In one embodiment, a material of the first polymer layer can be selected to allow oxygen inhibition to occur on a surface layer of the first polymer layer not in contact with the one of the two major surfaces of the lightguide. In one embodiment, the first polymer layer and the second polymer layer can form a laminated structure before arranging the first polymer layer on the one of the two major surfaces of the lightguide.

Process 1200 can proceed from block 1204 to block 1206. At block 1206, a second polymer layer can be arranged on the first polymer layer. A material of the second layer can be selected to have a Young's modulus that can be lower than a Young's modulus of the first polymer layer, and a refractive index of the second polymer layer can be greater than the refractive index of the first polymer layer. In one embodiment, a Shore hardness of the second polymer layer can be selected to be lower than a Shore hardness of the first polymer layer. In one embodiment, a portion of the first polymer layer can undergo curing while the surface layer of the first polymer layer remains uncured, and the second polymer layer can be applied to the uncured surface layer of the first polymer layer.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An optical system comprising:
a projection optics device configured to generate a light beam; and
a light-guide optical element comprising:
a lightguide comprising two major surfaces, wherein the light beam generated by the projection optics device and coupled into the lightguide travels through the lightguide by reflecting off the two major surfaces;
a transparent plate;
a first polymer layer arranged on one of the two major surfaces of the lightguide, wherein a material of the first polymer layer is selected to maintain total internal reflectance at the lightguide, and a refractive index of the first polymer layer is less than a refractive index of the lightguide; and
a second polymer layer arranged between the first polymer layer and the transparent plate, wherein a material of the second polymer layer is selected to have a Young's modulus that is lower than a Young's modulus of the first polymer layer, and a refractive index of the second polymer layer is greater than the refractive index of the first polymer layer.

2. The optical system according to claim 1,
wherein a Shore hardness of the second polymer layer is lower than a Shore hardness of the first polymer layer.

3. The optical system according to claim 1,
wherein the transparent plate has a larger constant of thermal expansion relative to the lightguide.

4. The optical system according to claim 1,
wherein the light-guide optical element further comprises a third layer arranged between the second polymer layer and the transparent plate.

5. The optical system according to claim 1,
wherein the lightguide comprises a coupling-out arrangement configured to direct light guided by the lightguide out of the lightguide.

6. The optical system according to claim 5,
wherein the coupling-out arrangement comprises a plurality of surfaces arranged within the lightguide at one or more oblique angles to the two major surfaces of the lightguide.

7. A light-guide optical element comprising:
a lightguide comprising two major surfaces, wherein a light beam generated by a projection optics device and coupled into the lightguide travels through the lightguide by reflecting off the two major surfaces;
a transparent plate;
a first polymer layer arranged on one of the two major surfaces of the lightguide, wherein a material of the first polymer layer is selected to maintain total internal reflectance at the lightguide, and a refractive index of the first polymer layer is less than a refractive index of the lightguide; and
a second polymer layer arranged between the first polymer layer and the transparent plate, wherein a material of the second polymer layer is selected to have a Young's modulus that is lower than a Young's modulus of the first polymer layer, and a refractive index of the second polymer layer is greater than the refractive index of the first polymer layer.

8. The light-guide optical element according to claim 7,
wherein a Shore hardness of the second polymer layer is lower than a Shore hardness of the first polymer layer.

9. The light-guide optical element according to claim 7,
wherein the transparent plate has a larger constant of thermal expansion relative to the lightguide.

10. The light-guide optical element according to claim 7,
wherein the light-guide optical element further comprises a third layer arranged between the second polymer layer and the transparent plate.

11. The light-guide optical element according to claim 7,
wherein the lightguide comprises a coupling-out arrangement configured to direct light guided by the lightguide out of the lightguide.

12. The light-guide optical element according to claim 11,
wherein the coupling-out arrangement comprises a plurality of surfaces arranged within the lightguide at one or more oblique angles to the two major surfaces of the lightguide.

13. A method of manufacturing a light-guide optical element, the method comprising:
providing a lightguide comprising two major surfaces, wherein the lightguide is configured to allow a light beam generated by a projection optics device and coupled into the lightguide to travel through the lightguide by reflecting off the two major surfaces;
providing a transparent plate;
arranging a first polymer layer on one of the two major surfaces of the lightguide, wherein a material of the first polymer layer is selected to maintain total internal reflectance at the lightguide, and a refractive index of the first polymer layer is less than a refractive index of the lightguide; and
arranging a second polymer layer between the first polymer layer and the transparent plate, wherein a material of the second polymer layer is selected to have a Young's modulus that is lower than a Young's modulus of the first polymer layer, and a refractive index of the second polymer layer is greater than the refractive index of the first polymer layer.

14. The method according to claim 13,
wherein a Shore hardness of the second polymer layer is selected to be lower than a Shore hardness of the first polymer layer.

15. The method according to claim 13,
wherein the transparent plate has a larger constant of thermal expansion relative to the lightguide.

16. The method according to claim 13, further comprising:
providing a third layer arranged between the second polymer layer and the transparent plate.

17. The method according to claim 16,
wherein the first polymer layer, the second polymer layer and the third layer are formed as a laminated structure before arranging the first polymer layer on the one of the two major surfaces of the lightguide and arranging the transparent plate on the third layer.

18. The method according to claim 13, further comprising:
providing a coupling-out arrangement in the lightguide, the coupling-out arrangement being configured to direct light guided by the lightguide out of the lightguide.

19. The method according to claim 18,
wherein the coupling-out arrangement comprises a plurality of surfaces arranged within the lightguide at one or more oblique angles to the two major surfaces of the lightguide.

20. The method according to claim 13,
wherein arranging the first polymer layer on the one of the two major surfaces comprises adhering the first polymer layer on the one of the two major surfaces of the lightguide.

21. The method according to claim 20,
wherein a material of the first polymer layer is selected to allow oxygen inhibition to occur on a surface layer of the first polymer layer not in contact with the one of the two major surfaces of the lightguide,
wherein the method further comprises:
curing a portion of the first polymer layer to undergo curing while the surface layer of the first polymer layer remains uncured; and applying the second polymer layer to the uncured surface layer of the first polymer layer.
